(19) United States
(12) Patent Application Publication
(10) Pub. No.: US 2023/0403274 A1
(43) Pub. Date: Dec. 14, 2023

(54) INDIVIDUALLY CENTRIC DEVICE, SYSTEM AND METHOD FOR AUTHENTICATING DEVICE USER IDENTITY

(71) Applicant: Individual Centricity Corporation, San Ramon, CA (US)

(72) Inventors: Joel Kenneth SOPPET, San Ramon, CA (US); Thomas Wigginton LOKER, San Ramon, CA (US); Juval LOWY, San Ramon, CA (US); David Charles ROBB, San Ramon, CA (US); Thomas Henry JOHNSON, DuBois, PA (US)

(73) Assignee: Individual Centricity Corporation, San Ramon, CA (US)

(21) Appl. No.: 18/328,438

(22) Filed: Jun. 2, 2023

Related U.S. Application Data
(60) Provisional application No. 63/350,160, filed on Jun. 8, 2022.

(51) Int. Cl. H04L 9/40

(52) U.S. Cl. CPC H04L 63/0876; H04L 63/18; H04L 63/102

(57) ABSTRACT

In accordance with certain embodiments, a method for authenticating the identity of a user for granting resource access includes using a user device to obtain, in connection with an authorized user of the user device, authorized user authentication data (AUAD), using the user device to obtain, for a current user of the user device, current user authentication data (CUAD), comparing the CUAD with the AUAD, calculating a confidence index based upon the comparison of the AUAD with the CUAD, the confidence index reflecting a confidence level that the current user is the authorized user, and making the confidence index available to a resource provider to grant access to a resource if the confidence index is above a predetermined threshold

### FIELD OF THE DISCLOSURE

The present disclosure relates generally to cybersecurity, and more specifically, to authentication of the identity of a user creating, modifying, destroying or using a device, network, network node, data, or other system.

### BACKGROUND

Authentication of a user's identity is a core element of security for both on-line and off-line computers, other devices, services and transactions, and also for access to systems dedicated to specific applications. Authentication of a user's identity is key to any process of authorizing access to an online account, a server, a network or other system. Whether a user is seeking to enter into an on-line transaction such as effecting a purchase from a commercial website, seeking access to information such as their medical records, seeking to enter into an on-line conference, or another type of electronic activity, the site or system to which the user seeks access needs assurance that the user seeking such access is indeed authorized for such access. User authentication is also important in granting access to specific user devices such as cell phones and granting access to houses, commercial buildings, or gated communities.

FIG. 1 is a block diagram of a prior art user authentication system 10. The system 10 includes a user device 12, typically comprising a cell phone or a personal computer, and an enterprise server 14. The user (not shown) typically initiates the interaction between the user device 12 and the enterprise server, and in the most basic form of system 10, the user provides a username, sometimes referred to as a user ID, and a password, to the enterprise server 14.

The server 14 maintains a database of known users and associated passwords (or a hashed ‘salted’ form of the password). Comparing a current user's submitted username/password with the enterprise server's appropriate database entry determines whether or not the username/password provided by the current user matches a database entry. If a match is verified, the user is determined to be authenticated, and is allowed to enter into transactions, access information, establish communications or take other actions on the site, in accordance with the enterprise server's purpose and implementation. Additional user-specific data may be provided by the user, maintained in the enterprise server, and used for user authentication.

It is significant that confidential information generally relating to the user—and specifically, personally identifiable information used for authenticating the user—is maintained in the enterprise server 14. The authentication process thus may be characterized as an enterprise-centric authentication process. Depending upon the purpose and operation of the server 14, it may maintain a record of other user related data. For example, a server supporting consumer sales would typically maintain an account record with shipping address, payment information such as credit card data, transaction history and even access history, but such information, though confidential and specific to the user, is not generally used for authentication of the user.

A more sophisticated version of prior art user authentication system 10 adds additional authentication information comparisons to the basic system 10. It monitors and stores additional information such as the user's normal pattern of accessing the enterprise server, both as to frequency and nature of utilization, historical user location pattern data if available, and challenge questions such as mother's maiden name, favorite restaurant, etc. Typically, it will seek additional authentication data when something suggests the actual user may not be the user indicated by the username. The additional authentication information is stored in the enterprise server and compared with data provided from the user device. Two-factor authentication has been implemented by some enterprise servers, and involves the enterprise server maintaining a record of either phone numbers, e-mail addresses, or both, for authentication purposes, and pinging the user by e-mail, text or voice for confirmation that the current user is the user represented by the username. Two-factor authentication came about because using password alone is not secure—someone can steal the password, or the user can use the same password on multiple sites, and if one site is compromised, the attacker can try that password somewhere else. Two-factor authentication avoids dependency on passwords as the sole authenticating feature, and two-factor authentication confirms the current user has access to the e-mail or phone belonging to the user associated with the username, but it does not provide assurance that the current user actually is the user associated with the username. These authentication processes are all enterprise-centric, and depend upon user authentication information stored in the enterprise server.

In both basic and more sophisticated versions of prior art system 10, the communication channels are shown as dashed lines in FIG. 1. The communication channel typically involves an internet connection and an IP (internet protocol) provider, and often a local area network with either Ethernet or Wi-Fi connection through a router. However, the local networks and the internet connections are substantially transparent, and the user device 12 is in two-way communication with the enterprise server 14 regardless of the configuration of the network.

The prior art examples of system 10 illustrate use of multiple forms of authentication information: passwords, challenge questions, and e-mail/phone contact information. A substantial number of additional forms of authentication information available for user authentication are available and are well documented in prior art, including fingerprint, voiceprint, retinal scan, and facial scan data, as well as other biometric data such as heart rhythm pattern, for example. The sensors needed to support some of this authentication information properties are currently available on some cell phones, while others could require collection of data from external sensing devices. Data from such external sensing devices can be communicated to a cell phone over a Bluetooth connection, available in most newer cell phones, or potentially available to computers over Ethernet or Wi-Fi. Fingerprints and facial recognition have been used to authenticate users for access to both computers and cell phones. In addition, both for access to cell phones themselves, and also to some application programs on cell phones, facial recognition algorithms provided by cell phones have been used to determine access to the phones and to the functionality of application programs, often providing access to a remote enterprise server through the application program. When an application program uses cell phone facial recognition program for determining access, it relies on the facial recognition process in the cell phone to 1) develop a database record for a specific user; 2) scan the current user for comparison with the database record; 3) determine how similarly/differently the data compares; and 4) make the binary decision that the current user is or is not the specific user represented in the database. The enterprise has thus relied on the cell phone maker for the integrity and reliability of facial scan data acquisition and relied entirely on the cell phone maker's judgment as to how close a match is required to establish authenticity. A perfect match would be an unusable requirement because people change hair length and style, sun exposure related skin shade, facial inflammation from allergies, etc., as well as differences between with and without glasses and recently, with and without pandemic-related facial masks. Additional factors such as distance between the camera and the face, and lighting conditions also impact the comparison results. Thus, the criteria for matching may be a moving target that the enterprise has no control over, or even specific awareness thereof. Furthermore, since one cannot easily change one's fingerprints or retinas, if the biometric information is compromised (as has happened), the user's identity is forever in-doubt.

As noted above, the prior art for authenticating a user in support of authorizing access to another device such as an enterprise server is enterprise-centric, usually dependent in substantial part on authentication information stored on the enterprise server. Typically, a user will access many enterprise servers, as everything from online commerce to social networking to video conferencing, and other systems requires such access. The consequence of enterprise-centric user authentication is that a user's authentication information is scattered across the internet in databases the user has no control over, and the user's awareness regarding the security of those databases ranges from little to none. An unauthorized breach by nefarious hackers of any one of those databases can result in the user's authentication information being published on the dark web. While some authentication information such as passwords can be changed if a breach occurs, other information like home addresses, social security number, responses to challenge questions like mother's maiden name or the street the user lived on when he was 12, are immutable, and once leaked, the users' privacy is forever violated. While the risk of a breach of a specific enterprise server, and thus having some authentication information exposed, is not huge, that risk is multiplied by the number enterprise servers a user has provided with his authentication information. As society moves to more and more on-line activity, the breadth of places to which users supply authentication information grows, and thus the risk of exposure grows. At the same time, increased need for security driven in part by a tendency toward increased on-line fraud, drives a trend toward requirements of increase amounts of authentication information on enterprise servers. When the only authentication information an enterprise server stored was a password, a breach of the server could be compensated for by changing passwords. With the understandable trend toward enterprise servers collecting more authentication information, the enterprises are more secure, but the user's authentication information is less secure.

Enterprise server systems typically use a simple algorithm for authentication. They will start with a request for authentication information, often only seeking a username and password. Sometimes that is all they need, while enterprises with higher security needs may check the history of that user in the enterprise server as well as additional authentication information like log-in location, and if a criterion is met, issue challenge questions. The outcome is inherently binary: the server either authorizes access or it does not. However, the nature of authentication itself is a much more continuous function. The more authentication information that is gathered and compared, and the more closely the gathered authentication information matches the authentication information in the enterprise server's database, the more assurance the user actually is who they claim to be. Gathering more authentication information can be intrusive of, and irritating to, the user, so enterprises tend to limit the level of data gathering to only that which they consider essential to support its currently perceived security needs. While that approach has been adequate in some circumstances, there are other circumstances where the degree of confidence needed in the authentication has dependencies such as the part of the enterprise server to which access is sought, and who is purportedly seeking such access. Confidence in the user authentication of someone seeking to access medical records in a hospital, access to which is regulated and limited by federal law, requires a different level of authentication confidence than the authentication confidence needed for someone seeking to enter a staff educational video conference, although both actions may be occurring in the same enterprise server. An ability to address different requirements in levels of confidence in user authentication so that the burden of the authentication process can be balanced against various levels of needed security is not well addressed in prior art. Furthermore, prior art has issues with maintaining a chain of trust, and tends to authenticate only the immediate caller. This leaves them open to a luring attack. Even if that caller was authenticated with higher scrutiny, if that caller was lured into doing an attacker's bidding, and the attacker has only passed rudimentary authentication, the system cannot detect that.

Most current on-line systems requiring user authentication do so once, at log-in. If a user changes without a log-out/log-in occurring, the on-line system continues as if the previous user is the current user. While that may sometimes be the first user's intent, it can also occur completely outside the awareness of the first user if that user simply neglects to log-out.

Additionally, most current authentication systems accept as authentic any user who provides the correct responses such as password and correct answers to challenge questions. While some systems, typically home and office security alarm systems, provide for a distress code to be substituted for a password, current systems generally only establish the user's authenticity. They do not provide an involuntary means of determining whether a user is seeking access under duress.

### SUMMARY OF THE DISCLOSURE

Various details of the present disclosure are hereinafter summarized to provide a basic understanding. This summary is not an exhaustive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

Representative embodiments set forth herein disclose various example implementations of the method and system of a user-authentication device, system and method. Disclosed is a device, system and method for accessing information relating to a current user from a plurality of sources and sensors associated with a user device, applying a multimodal analysis of the degree to which the collected information relates to identification metrics previously stored in a specific user's personal user profile in the user device, calculating a composite confidence index from those relationships representing the confidence that the current user is the user represented in the specific user's personal user profile on the user device, and providing that confidence index when needed. The confidence index estimate of confidence that the current user is the specific user that created the personal user profile is based upon a multimodal comparative analysis of identity related data gathered from that current user and corresponding identity related data stored in the user device as a personal user profile relating to the specific user.

In accordance with one aspect, there is provided a method for estimating confidence in the authenticity of a user of a device, a network or other system, with the authentication process implemented on an individually-centric user device such as a cellular phone, personal computer, implantable device, or other electronic device, referred to hereinafter as a user device, typically incorporating a processor or discreet logic, memory, system control software, one or more sensors, and one or more communication interfaces such as cellular radio, Bluetooth, Wi-Fi, Ethernet, and USB. Features in the user device will enable the user device to obtain data specific to identification of the user from a plurality of sources. Such data includes visual images supporting facial recognition, vocal data supporting voice prints, and responses to queries about information personal to the user, as well as data such as motion data, location data, heart rate, proximity to other known devices, and body temperature that when collected over time, and characterized as patterns, can be useful in identity authentication. Authentication metrics related to a specific user are generated from sensor data relating to that user on the user device as well as additional data such as keyboard entry data and data from specialized devices providing data through connectivity networks like Wi-Fi or Bluetooth, all of which data is maintained in a personal user profile within that user device. Authentication metrics of a current user are generated by the user device and compared with the stored metrics in the specific user's personal user profile. Based upon a multimodal comparative analysis of collected identification metrics for the current user and the stored metrics in the personal user profile for the specific user, a confidence index is generated reflecting the degree of confidence that the current user is the specific user represented in the personal user profile.

In accordance with certain embodiments, the process in the user device of determining a confidence index is ongoing, with newly determined confidence index values reflecting both the acquisition of additional User Authentication Data, or “UAD”, and also changes that occur in individual sources of UAD. Thus, the confidence index may increase as additional UAD is accessed and analyzed, but it may also decrease, potentially with an abrupt and significant decline, as would be expected for example if the user device passes to a different user, or when it detects duress.

In accordance with certain embodiments, the confidence index is used to determine access to the user device itself and specific features of the user device. The specific user that generates the personal user profile designates within the user device the confidence index value that must be met or exceeded for access to the user device, as well as the confidence index value that must be met or exceeded for access to a broader scope of features of the user device. The confidence index value requirements for accessing differing features of the user device are individually set, allowing requirements for a greater confidence index value for features requiring greater confidentiality, and a smaller, or even zero confidence index value, for features where confidentiality needs are minimal or none at all. For example, if the user device is a cell phone populated with multiple application programs, a user might set a high confidence index value requirement to access a stock portfolio management application program, but a very low or zero confidence index value requirement to access a solitaire game.

In accordance with certain embodiments, the user device will support establishing a form of registration on other devices whereby the user device is uniquely identified to the other devices through provisions built into the user device, installed in software, or downloaded as a part of a device certification code. The unique identifier may be from several different origins: it may be provided within, and unique to, each downloaded application program; it may be a unique designation built into the user device such as a serial number; it may be a certification code generated by a second party device, or by a third-party device, from which the user device receives and stores the certification code; it may be a network address of the user device; or it may be any other identifier that uniquely identifies the user device. This registration process provides the other devices with assurance that, when the unique identifier is sent to other devices in subsequent connections to the user device and matches a record of the identifier stored during the registration process, those other devices are connecting to the user device that was registered. Having established the validity of the user device, the other devices can then evaluate the confidence index provided by the user device to decide whether the confidence index value is sufficiently high to meet that device's criteria for accepting that the current user on the validated user device is the actual user that is represented in the personal user profile on the user device.

In accordance with certain embodiments, a similar system to one described above is utilized, but validation of the user device is conducted by a plurality of devices working in concert to validate the current user's device. The authentication process of data gathering, analyzing and calculating the confidence index remains in the user device, with a process of validating the user device in the other devices. The plurality of devices all work in concert to validate the user device. Each reports to the others whether or not the user device seeking access matches a registration on that device. Recognition by multiple devices increases the reliability of validation. Thus, the multi-device validation makes it difficult for someone to hijack the user device's confidence index determination of the legitimate user to authenticate someone else. Most of the processes involved in this aspect of the user authentication assurance process is automated, and requires very little interaction by the user.

In accordance with certain embodiments, the user device is used to access a resource device; a validation process utilizing a certification code, optionally including a refresh cycle, is utilized for validating that the user device is associated with a user ID. The resource device may be serving any number of different purposes, including, as examples: web-based commerce, medical services including access to appointment schedules and medical records, on-line banking, social networking and network conferencing. Authentication metrics related to a specific user are generated by the user device using available sensor data and a multimodal analysis to develop a personal user profile for the specific user, and that personal user profile is maintained within the user device. Authentication metrics of a current user are generated by the user device and compared with the stored metrics in the personal user profile to determine a confidence index that provides an estimate of the confidence that the current user is the specific user represented in the personal user profile. Using the user device, the user will seek to access a resource device by providing a user ID, and, the user device, having calculated a confidence index estimate of the confidence in the authenticity of the user, will forward the confidence index to the resource device. The user device may be configured to send the confidence index proximate in time to the sending of the user ID, or alternatively, could be configured to wait until the resource device responds to the user ID by querying the user device for the confidence index. In this aspect, validation routines are located within the resource device, and operate to assure that a user device providing a user ID and confidence index is the same user device legitimately associated with the user ID. The validation process starts when the user device initially registers with the resource device. The resource device generates and sends a unique certification code to the user device while maintaining a database associating the user, the user ID, and the certification code. The user device stores the certification code, and maintains a record of association of the certification code with the resource device. User devices will typically be utilized for access to many different resource devices, and with this method of validating the user device, the user device will keep a certification code from each resource device along with its association to its respective resource device. Upon the user seeking subsequent access to the resource device, the user device will send the certification code associated with the resource device to the resource device as well as the confidence index and the user ID. Provided the certification code matches the certification code expected by the validation routines in the resource device, the resource device will evaluate the level of the confidence index. If that confidence index meets its criteria, it will grant access. Optionally, the resource device will refresh the certification code by generating, storing, and sending to the user device a new unique certification code. The user device will replace the old certification code with the new certification code in its record, associating the certification code with the resource device. Also, optionally, the user device and the validation routines in the resource device could be configured to eliminate the need for the user ID, because the certification code is itself a unique identifier to both the user device and the resource device. Additional security provisions can also be added, including as an example, an additional record provided by the validation routines in the resource server to the user device, and, as part of a sign-in process on the resource device, a query is sent from the resource device for a character string at a randomly selected location within that additional record. Since the requested string would be nominally different with each attempted access to the resource device due to the random selection of the location designation, a prior capture by a nefarious actor of an access exchange over an insecure transmission would not provide the needed credentials for a subsequent access.

In accordance with certain embodiments, the user device is connected over a network to a resource device to which a user seeks access, and which resource device accesses a validation device to validate the user device. In this aspect, the validation device performs functions in a manner similar to the validation routines of a resource device described above, except that instead of validation routines in numerous resource devices, each generating certification codes for storage in and retrieval from the user devices, the validation device performs its function for many different resource devices, and generates unique certification codes for each user device. The user will attempt to access the resource device by providing a user ID and a confidence index estimate of the confidence in the authenticity of the user to the resource device. The resource device then provides the user ID to a validation device on which the user device must have previously been registered, and, by means of that registration, the validation device will have sent a certification code to the user device. The validation device maintains a database that associates each user device with a user device address, a user ID, and the certification code that it sent to the respective user device. The validation device then queries the user device, and, provided the user is seeking access to the resource device, the user device responds with the previously received certification code. Provided the certification code received from the user device matches the certification code associated with the respective user device in the database maintained by the validation device, the validation device then sends the resource device certification of the user device. Optionally, the validation device then generates a new certification code, replaces the old certification code in its database with the new certification code, and sends the new certification code to the user device for use the next time the certification process is initiated for the respective user device. In this manner, the user device that is in contact with the resource device determines and reports to the resource device the degree of confidence that the current user is the user associated with the respective user device, and the validation device certifies to the resource device that the user device in contact with the resource device is the user device associated with the user ID. The resource device then determines whether the confidence index value meets its requirements for granting access. An optional feature of the configuration described above, using a separate validation device, includes provision by the validation device to the resource device, not only validation that the user device is the expected user device, but also that the user authenticated by the confidence index is who they have represented themselves to be.

In accordance with certain embodiments, a similar system to one discussed above is utilized. However, an auxiliary user device such as a personal computer is also utilized, wherein the user utilizes the auxiliary user device to access the resource device. The authentication process of data gathering, data analyzing and calculating of the confidence index remains in the user device. Upon receiving a request from the auxiliary user device, the user device sends the current confidence index value to the auxiliary user device for forwarding to a resource device. The process of certifying the user device through validation routines in the resource device is similar to that described above, except that the user device, now not being the device that initiated contact with the resource device, does not respond to the validation routines in the resource device until and unless it has received a request from the auxiliary user device or directly from the user notifying the user device to send a stored certification to the validation routines in the resource device. The communication link carrying the alert from the auxiliary user device to the user device should be a short-range system such as Bluetooth, thereby making it difficult for someone to hijack the user device's confidence index determination of the legitimate user to authenticate someone else on an auxiliary user device. An alternative to such automated alert response is to have the request show up visually and/or audibly on the user device to notify the user and require an active response by the user on the user device to enable response to the validation routines. Most of the processes involved in this aspect of the user authentication assurance process is automated, and requires very little interaction by the user.

In accordance with certain embodiments, the inventive authentication process may be configured to operate in a closed environment such as in a business's closed, employee only, network. The network system is configured with a resource device and multiple user terminals supporting multiple users, typically supported by Ethernet and/or Wi-Fi, all connected through a router or other connection device. The system may be configured using various devices such as legacy dumb terminals, or smart, microprocessor-based computers, but the system configuration provides multiple access points, referred to herein as user terminals, to the resource device. Because access to the multiple user terminals may not be physically secure, because the user terminals may intentionally be available for use by numerous different authorized users, and because the business may provide differing levels of access to different portions of the resource for different users, authentication of each specific individual user may be essential. When security considerations dictate more than a mere password for authentication, the inventive user authentication process provides minimally intrusive but substantially secure authentication. The inventive user authentication system assesses the authenticity of a user in a user device and determines a confidence index as discussed above, with each user having his personal user device that compares current user authentication metrics with a specific user's set of user identification metrics stored in his personal user device. The user terminals and user devices are connected to the resource device through the router or other connection means, and user devices interact with validation routines located within the resource device. Using a user terminal, the user sends his user ID from the user terminal through a router, or other connection means, to the resource device, and the resource device activates validation routines, which in turn send an authenticity query through the router or other connection means, to the appropriate user device associated with the user ID, seeking confirmation that the user terminal that provided the user ID and is seeking access to the resource device is the user associated with that user ID. The user device will alert the user with a visual and/or audible alert, and require an active response from the user to enable the user device to respond to the validation routines. If that active response is provided, the user device will send the confidence index for the current user to the resource device. Thus, the resource device has received a confidence index indicating a degree of confidence that the user is the user whose authentication metrics are stored in the user device, and the user has verified that he is the user using the auxiliary user device that sent the user ID to the resource device. The resource device will then determine whether the confidence index meets the business's requirements for granting access, or a particular degree of access, to the resource device.

Several examples have been presented utilizing the authentication method and system to provide a confidence index in support of decisions to provide access. The decision to provide access is usually performed on a device other than the user device on which the confidence index is calculated, and that decision making device is not privy to the data in the specific user profile used to calculate the confidence index, but both devices have the option of maintaining a record of both the occurrence of the attempted access and the confidence index provided in support of the attempted access. Such a record may be especially important where multiple individual access is involved, and changes, deletions, additions, etc. are performed by different access events, and different actors. If, for example, a group of people coalesce to edit a document protected by the authentication process of the invention, and a question later arises as to the authenticity of the contributor of some of the edits, tracking the confidence index supporting the accesses by which those edits were allowed may be an important forensic tool for assessing the history and reliability of the document edits. Those with skill in the art will no doubt see many other applications and advantages in being able to track the historical record of confidence index supported access. Access as used herein generally means access to a resource, which may be information and/or services provided by online and/or networked (private or public network or a combination) platforms, websites, servers, and the like. The resource may also be an IoT device or a physical device such as a user device including a smart phone, tablet, laptop computer, desktop computer, server, smart television, as well as other discrete logic or microprocessor-based devices, or any other hardware device or component, including for instance an automobile or other vehicle, facilities or premises and the like, and so on; or it may be any program or routine or software/firmware executing on such a physical and/or IoT device or the like.

Features of data collection, data analysis, validation of user devices and systems to which the disclosure can be applied are many, and the association of features together in describing aspects thereof have been combined in examples to facilitate understanding. The selection of combination choices is not intended to be exclusive or exhaustive, and combining different aspects in additional configurations is contemplated.

It is an advantage of the disclosure that authentication of the identity of a user seeking access to a device, a system, or to data, is a user-centric process, with the authentication analysis based upon a user profile of UAD metrics that is substantially all stored in the user device in the user's control, and not duplicated across multiple other devices scattered across the internet.

It is a further advantage of the disclosed user authentication system that it determines and reports a confidence index as a value on a continuum, supporting individual determination of the needed balance of security and intrusiveness of the authentication process by any specific device, software, data, server, system, or portion of a server or system that a user seeks to access.

It is a further advantage of the disclosed user authentication system that it supports a process which can provide certification that the device assessing authentication data is the device associated with the specified user.

It is a further advantage that the disclosed user authentication system provides continuously calculated estimate of the confidence that the current user is the specific user associated with the user device, and provides corresponding changes in the confidence estimate if the user of the user device changes to a different user.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

FIG. 1 is a block diagram showing a conventional prior art user authentication system employing a user device and a resource device, and illustrating the interactive communications between them.

FIG. 2 is a block diagram showing elements of a user authentication system for authenticating a user for access to a resource device wherein a user device maintains user identification data and implements criteria for estimating authentication of the current user, and the resource device utilizes internal routines to validate the user device, in accordance with certain embodiments.

FIG. 3 is a block diagram showing elements of a user authentication system for authenticating a user for access to a resource device, wherein a user device determines criteria for estimating the authentication of the user, and a validation device is utilized to validate the user device to the resource device, in accordance with certain embodiments.

FIG. 4 is a block diagram showing elements of an additional exemplary embodiment of a user authentication system, similar to the system of FIG. 2, but adding an auxiliary user device from which the user communicates with the resource device, in accordance with certain embodiments.

FIG. 5 is a block diagram showing an additional exemplary embodiment of the inventive user authentication system applied to a closed network within an enterprise having multiple users and multiple user interface terminals, wherein the authentication system does not require internet or other external network access, and where the authentication system supports differing levels of user access by supporting levels of confidence in user authentication on a continuum.

FIG. 6 is a block diagram showing an application of the authentication arrangement in a peer-to-peer network of user devices, in accordance with certain embodiments.

FIG. 7 is a flow diagram an authentication process implemented in the user device in accordance with certain embodiments.

FIG. 8 is a flow diagram of a process of estimating a confidence index from data acquired from a plurality of sensors, in accordance with certain embodiments.

FIG. 9 is a block diagram of a computer system that may be used to implement one or more of the systems or methods described herein in accordance with certain embodiments.

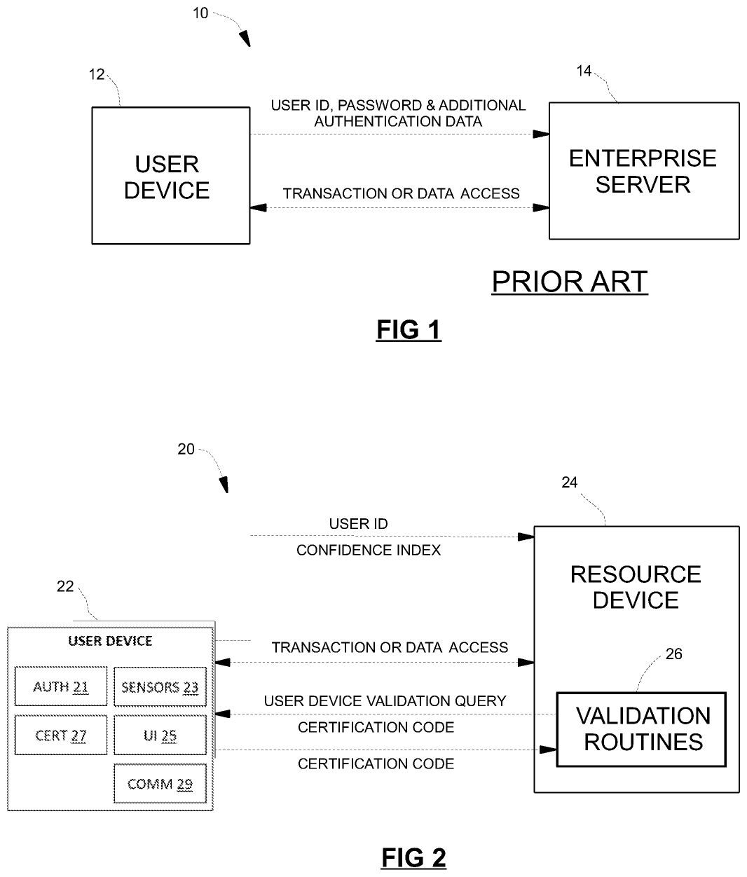

### DETAILED DESCRIPTION

Embodiments of the present disclosure will now be described in detail with reference to the accompanying Figures. Like elements in the various figures may be denoted by like reference numerals for consistency. Further, in the following detailed description of embodiments of the present disclosure, numerous specific details are set forth in order to provide a more thorough understanding of the claimed subject matter. However, it will be apparent to one of ordinary skill in the art that the embodiments disclosed herein may be practiced without these specific details. In other instances, well-known features have not been described in detail to avoid unnecessarily complicating the description. Additionally, it will be apparent to one of ordinary skill in the art that the scale of the elements presented in the accompanying Figures may vary without departing from the scope of the present disclosure.

Embodiments in accordance with the present disclosure generally relate to cybersecurity, and more specifically, to authentication of the identity of a user creating, modifying, destroying or using a device, network, network node, data, or other system.

In accordance with certain embodiments, a novel approach for user authentication process and system, based on developing and providing an estimate of confidence in a user's identity, determined through a multimodal analysis of data collected and analyzed in a device in the user's control, is disclosed. As a general aim, one aspect of the disclosure acts on a principle of user-centric generation of an authentication confidence estimate, and on the continuously calculated and updated provision of a continuous-scale estimate as to the authenticity of the current user, thereby supporting varying responses as a function of security needs.

One approach, according to certain embodiments, is to develop a personal user profile for a specific user of data gathered by user a device 22 of system 20 in FIG. 2, and using a multimodal comparison analysis, to compare the data in that personal user profile with corresponding data, which may also be gathered by user device 22, but relating to a current user. A further feature is that the multimodal comparison analysis produces a confidence index, which is a scalar estimate of confidence that the current user and the specific user represented in the personal user profile are the same person.

User device 22 includes an authentication module 21, which may be dedicated hardware provisions, firmware, and/or an application program or software, or a combination of software and hardware, to acquire user authentication data, or UAD, associated with the user. Authentication module 21 is operable to develop statistical descriptors for appropriate metrics quantifying the observed UAD, develop cross-correlations between different metrics where useful, and create a personal user profile relating to the specific user on the user device 22 of metrics descriptive of that user.

The personal user profile containing the UAD of an authorized user acts as a reference for determining the authenticity of a subsequent user of the device 22. The UAD of the authorized user may be referred to herein as authorized user authentication data, or AUAD; and the UAD of the subsequent (or “current”) user may be referred to herein as the current user authentication data, or CUAD. The user authentication module 21 gathers the corresponding, or a subset of the corresponding, UAD metrics from sensors 23 in the device, and/or from a user interface 25 of the device, and/or from a communication links 29 for receiving the information from external sources, for any current user of the user device. The authentication module 21 compares the UAD metrics relating to the current user (current user authentication data, or CUAD) with the UAD metrics in the personal user profile (authorized user authentication data, or AUAD), and by determining the degree of similarity, accounting for expected variation, and weighting the various data comparisons for the reliability of each metric in authenticating identity, algorithmically determines a confidence index expressing the confidence that the current user is the user represented in the user profile—that is, the authorized user. Importantly, the confidence index not merely a binary YES/NO decision as to whether or not the current user is the authorized user, but instead merely reflects some generally non-definitive degree of confidence in that regard.

Some of the UAD metrics may require time to acquire and to develop time-related statistical representations thereof, and acquisition of some metrics may be more intrusive than others, requiring certain actions of the user such as speaking, adjusting user or camera to focus the camera on a facial or other view, or responding to questions. The amount of UAD generated for a current user may thus be limited, at least initially, and with a small amount of UAD authentication module 21 may determine a lower confidence index for the specific user whose personal user profile is used for comparison than would be determined with additional UAD. Authentication module 21 addresses this by looping back, and continuously gathering UAD, determining UAD metrics, comparing the additional UAD with the UAD in the profile of the authorized user, and thereby iteratively updating the confidence index. Provided the current user is the user represented in the personal user profile, the confidence index may start low, as a function of the limited amount of the current user's UAD received, but will increase as the amount of UAD increases through the continuous data gathering and updating process. Authentication module 21 will maintain the current confidence index value, and provided the current user is continuing to use user device 22, will deliver the confidence index on demand.

User device 22 is typically a cell phone, although, alternatively, personal computers, notebook computers, computer pads and even smart televisions, as well as other discrete logic or microprocessor-based devices incorporating sensors, user interfaces and/or communication capabilities could be used. A resource device 24 may be serving any number of different purposes, including, as examples: web-based commerce, medical services including access to appointment schedules and medical records, on-line banking, social networking and network conferencing, and so on. In this example of the authentication system 20, a user seeks to access resource device 24 through user device 22. In order to utilize certain features by the resource device 24, user device 22 may be configured to perform authentication functions, which may be built into the user device, or if using a device such as a cell phone, may be provided through downloaded application software. Such functionality may be achieved through authentication module 21. A user registers their device 22 with resource device 24 in a process typically referred to as establishing a user account on resource device 24. In this registration process, validation routines 26 within resource device 24 may be provided with the user's user ID, sometimes referred to as a username. The validation routines 26 respond by generating a unique certification code corresponding to the user device 22 and providing it to the user device. The user device 22 maintains (either onboard or externally under its control) a database (not shown) that stores the received certification code with an association to the resource device 24. The validation routines 26 maintain (either onboard or under their control) a database (not shown) that associates the user ID with the certification code generated by the validation routines 26. An alternative manner of certifying the identity of the user device 22 is for the user device to report a device identification code, either one incorporated in the user device, or a unique identification code provided in user device certification module 27. As part of the registration process, resource device 24 can request certain additional information dependent upon the purpose of resource device 24, with an e-commerce site, for example, typically requesting data including shipping address and payment information such as credit card numbers and related credit card information. A medical clinic might seek medical insurance information. Any subsequent attempt by the user to access resource device 24 necessitates assurance to the resource device 24 that the user is actually the authorized user who is associated with the account that was opened and with user account information that resource device 24 has stored. Upon seeking access to resource device 24, the user will provide to resource device 24 the user ID used when first registering, along with either the certification code stored in the user device, or the device identification code, as appropriate. In accordance with certain embodiments, the user device 22, and specifically the authentication module 21, produces a confidence index that provides resource device 24 with an estimate of confidence that the current user is the user associated with the user device (i.e., the authorized user), and the certification code or device identification code provides the validation that the user device is the user device associated with the user that opened the account. The confidence index is a function of the comparison between the CUAD and AUAD, with a high confidence index indicating that the current user UAD strongly matches the authorized user UAD, and low confidence index indicating the opposite. Resource device 24 can then determine whether the confidence index presented is sufficiently high to meet its criteria for granting access, for example based on a confidence index threshold that may be adjustable by the user and/or administrator of the resource device 24. Moreover, different (potentially adjustable) confidence index thresholds may correspond to different levels of access, with fund withdrawals and transfers from an online bank account for example having high threshold requirements compared to mere balance inquiries.

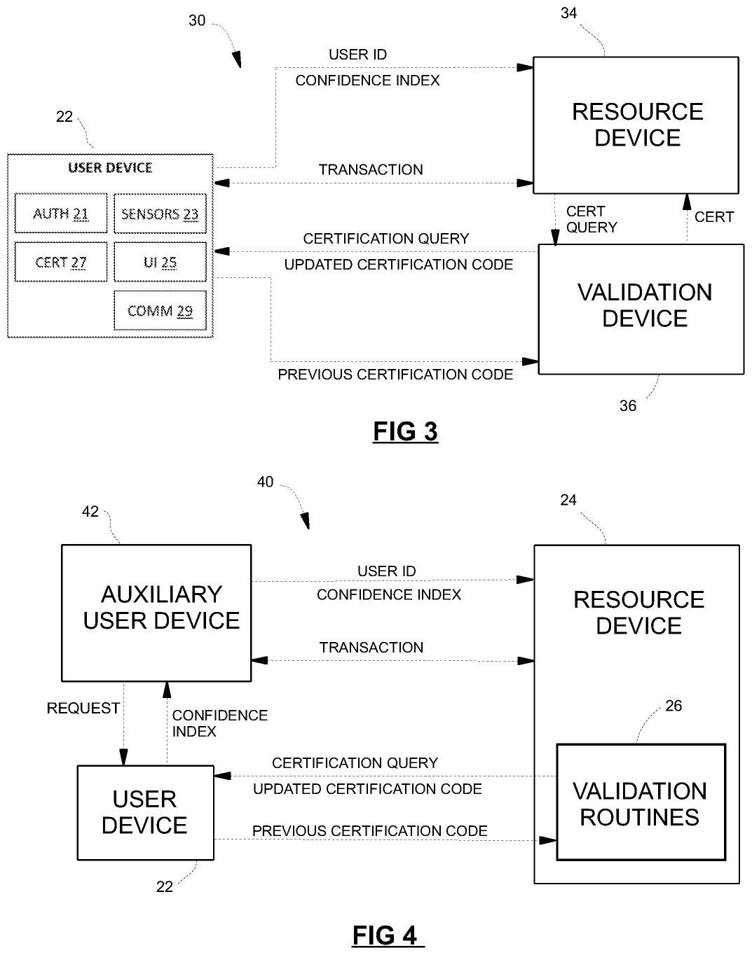

The system 30 of FIG. 3 is directed to an embodiment that further incorporates a validation device 36 that functions in a manner similar to the validation routines 26 described above, except that validation device 36 is separate from resource device 24, and can service multiple, unrelated, resource devices 34. The user device 22 may be configured to support the authentication process as described above, using an authentication module e.g., either through implementation in hardware, firmware, or potentially through an application program, or any combination of these, with user device 22 having been registered on validation device 36, providing a user ID and either receiving and storing a certification code, or sending a device identification code. The user ID and the certification code or user device identification code will be paired in storage on both user device 22 and on validation device 36. When a user seeks to access resource device 34, the user sends a user ID and a confidence index developed in the user device 22 by comparing UAD acquired for the current user (that is, the CUAD) with an authorized user personal user profile (AUAD) previously generated by the authorized user as described above. Resource device 34 receives the user ID and confidence index, and uses a resource device version of certification module 31 to send a certification query to validation device 36, which query includes the user ID, and indicates that the user is seeking to access the resource device 34. Validation device 36 sends a certification query to user device 22, and, provided user device 22 is seeking access to resource device 34, user device 22 responds with either the certification code previously received from validation device 36 or the user device identification code. Validation device 36 compares the certification code or the user device identification code provided by user device 22 with the certification code or the user device identification code, respectively, it has previously stored with association to the user ID, and, provided they match, validation device 36 sends a certification to resource device 34 certifying that the user ID provided by resource device 34 is associated with the specific user device 22 through which the user has sought to access resource device 34. Resource device 34 then has validation of user device 22 from validation device 36, and a confidence index, which is a function of the comparison between the CUAD and AUAD, on which to base its assessment as to whether to grant access to user device 22. For an added degree of security, following certification to resource device 34, the validation device may, optionally, also generate and send a new certification code to user device 22, and both user device 22 and resource device 34 then replace the old certification code with the new certification code in their respective memories.

Some distinctions in operation between the system shown in FIG. 2 and the system shown in FIG. 3 include the potential need with the system shown in FIG. 2 for user device 22 to store a unique certification code for each resource device 24 that the user accesses, whereas the system shown in FIG. 3 only requires user device 22 to store a single certification code or user device identification code. Additionally, the system shown in FIG. 2 requires resource device 24 to maintain either a certification code or a user device identification code for each user, while the system shown in FIG. 3 does not require resource device 34 to retain either for any user account.

In certain embodiments the data used for authenticating the identity of the user is maintained in the user device 22 and not in resource device 24/34 or validation device 36. Typically, a user will create accounts on many different resource devices, but by placing the process for determining the confidence that the current user is the specific user associated with the respective user ID entirely within user device 22, the data used for authentication is consolidated in a single device in control of the user. This user-centric approach to authentication keeps the user's personal data always in their possession and control.

Another system in accordance with certain embodiments is illustrated in FIG. 4. The system of FIG. 4 further incorporates an auxiliary user device 42 such as a personal computer, wherein the user utilizes the auxiliary user device as their access point for communication to resource device 24. User device 22 maintains a personal user authentication profile (AUAD), acquires authentication data from the current user (CUAD), uses multimodal analysis to compare the authentication data relating to the current user with the authentication data in the user authentication profile, and calculates a confidence index, all as described above. With the system shown in FIG. 4, the user accesses user device 22 and resource device 24 through auxiliary user device 42, requesting from user device 22 a confidence index which has been generated by user device 22 in the manner described above, and sending that confidence index, along with a user ID, to resource device 24 by way of auxiliary user device 42. Upon receiving the attempted access from auxiliary user device 42 providing the user ID and confidence index, resource device 24, through validation routines 26, activates the user device validation process described above—that is, it determines whether the confidence index meets a predetermined threshold and the user ID is a match for example. User device 22 only responds to the certification query from the validation routines 26 because it received the request for the current confidence index from auxiliary user device 42, but it may be configured to also require an affirmative response on user device 22 by the user to allow the certification code to be sent.

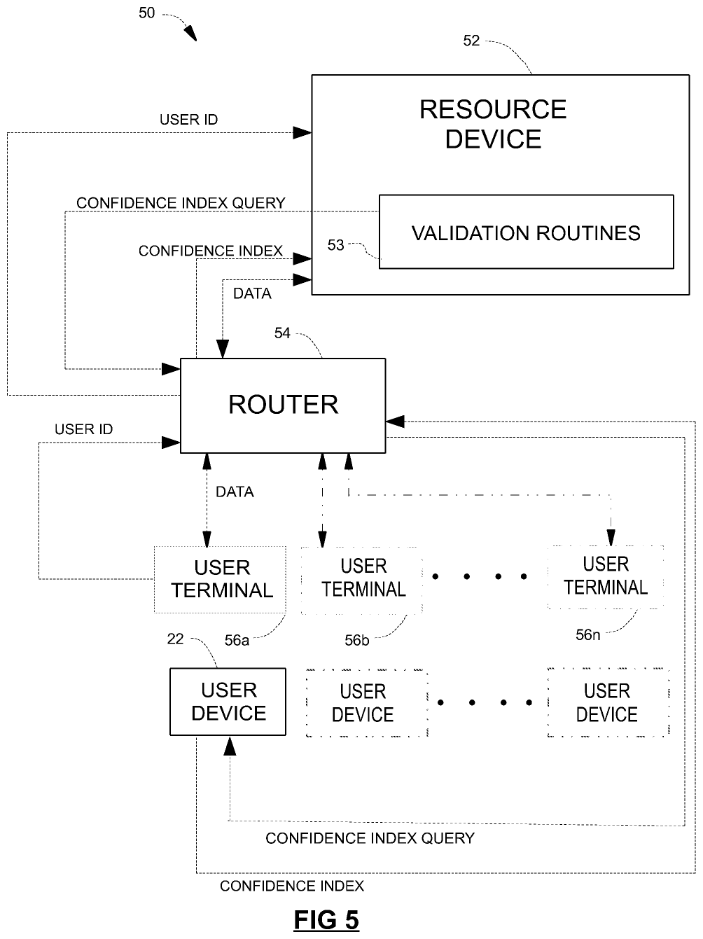

FIG. 5 shows an example embodiment of a system 50 using a user authentication system on a closed network in accordance with certain embodiments. Resource device 52 is a centralized device on a private, closed network facilitated by router 54 and supporting multiple user terminals 56a-n (56 collectively). The user terminals 56 are communication access devices such as legacy dumb terminals, or smart, microprocessor-based computers. However, the system configuration provides multiple access points, referred to herein as user terminals 56, to resource device 52. The network typically connects user terminals 56 through router 54 to resource device 52 by Ethernet and/or Wi-Fi, although other devices and connection means are also contemplated. The resource device 52 is configured to evaluate a confidence index from any user that seeks access, and grant access to a resource sought from resource device 52 only if the confidence index meets a predetermined threshold value associated with the respective resource. With this embodiment, calculation of a confidence index is determined in a user device 22 in the same manner described above. When a user seeks access to a resource through user terminal 56a, for instance, the user sends a user ID from terminal 56a through the network and router 54 to resource device 52. Resource device 52 includes validation routines 53, on which the user previously registered, creating a record associating the user ID, and a network addressable address through which validation routines 53 can query user device 22. Resource device 53 uses the validation routines 53, and the stored record, to send a confidence index query through router 54 to user device 22 seeking the confidence index associated with the provided user ID. Upon receiving the query from resource device 52, user device 22 notifies the user using an audible and/or visual alert, and upon receiving an active response from the user, forwards the confidence index to resource device 52 through router 54. Resource device 52 has thus received a confidence index from user device 22 providing an estimate of confidence that the current user is the authorized user in the user profile in user device 22, supporting evaluation as to whether to grant access, and also received validation that the user device 22 is associated with the user ID, by being accessed through its address associated with the user ID in validation routines 53.

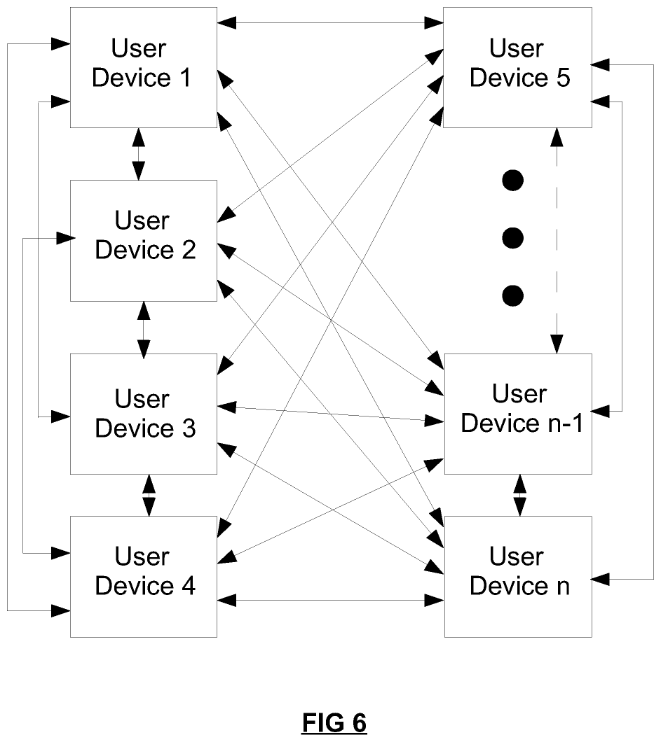

A block diagram showing a multipoint network of peer-to-peer interconnected user devices utilizing the authentication system in accordance with certain embodiments is shown in FIG. 6. Each user device, user device 1 through user device n, is configured with authentication routines either built into the hardware of the user device or implemented through firmware or software. The user devices are substantially like those described above, having a plurality of input sensors and/or communication links and/or user interfaces from which to generate and/or receive UAD, and the user devices include the ability to access UAD for, and develop a personal user profile of, a specific user (AUAD), acquire UAD for a current user (CUAD), and determine a confidence index providing an estimate of confidence that the current user is the specific user represented in the personal user profile. The peer-to-peer network of FIG. 6 is formed by each of user devices 1 through n registering on each of the other user devices 1 through n, wherein the registration process requires each user device to exchange certification codes with each other user device in the peer-to-peer network. Each user device generates a unique certification code for each user device it registers with in a mutual certification arrangement. Both send and receive a certification code in each registration process with another user device. Both user devices store both certification codes, and similarly store both the sent and received certification codes for each user device with which it registers. After the peer-to-peer network has been created through the registration process by each pairing of user devices, communications between user devices are initiated by each respective user device exchanging and comparing certification codes to provide a degree of validation of the user devices to which it connects in the peer-to-peer network, and exchanging confidence indexes to provide a basis for authenticating the user on the validated user device. A further validation of a user device, for example user device 1, is accomplished by a user device, for example user device 2, polling another user device, for example user device 3, with a query as to the validity of a user device 1, and user device 3 then seeking a certification code exchange with the user device 1. If the certification code exchange between user device 1 and user device 3 does not produce matches with the respective records of certification codes, the user device 3 notifies user device 2 that user device 1 appears to be an imposter device. This additional validation step would identify a network breach where for example a nefarious intruder had managed to intercept a prior certification exchange communication between user device 1 and a user device 2, and thus had captured the certification codes each had assigned to each other, but did not have the certification codes associated with other users on the peer-to-peer network, and could therefore not connect to user device 3. User device 2 will not allow full connection from user device 1 if user device 1 is invalidated by its failure to connect with user device 3, regardless of the confidence index user device 1 provides to user device 2.

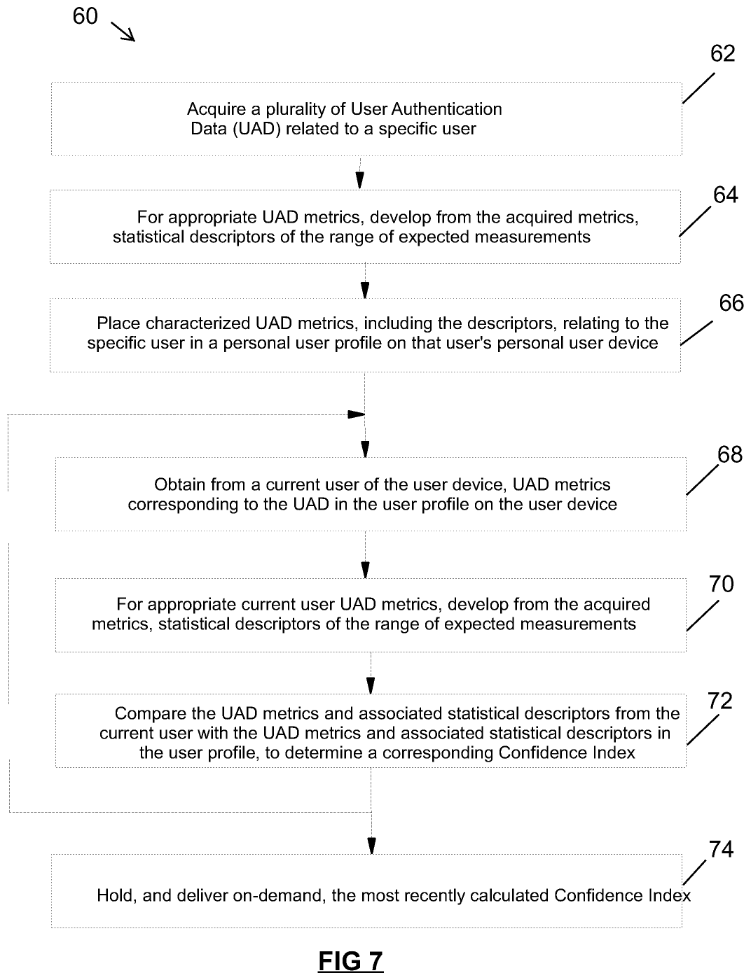

The process through which a confidence index is calculated in accordance with certain embodiments is shown in the flow diagram FIG. 7. The process 60 begins at 62 with a user device acquiring a plurality of user authentication data, referred to as UAD, related to a specific user (i.e., the AUAD), for example by way sensors 23, user interface 25, and/or communication links 29. The user is nominally the person normally in possession and control of the particular user device that acquires the authentication data, although any particular user device could be used for user authentication by more than a single user as discussed in more detail below. The authentication data is acquired through a key board or key pad of the UI 25 for instance, and/or through a plurality of sensor devices 23 in the user device that may include, without limitation, sensors such as finger print scanner, camera, microphone, motion sensor, and GPS coordinate sensor, and also through additional sensors that may be accessed through communication links 29 such as, without limitation, Wi-Fi, Bluetooth and Ethernet. The UAD thus used in the multimodal comparative analysis may include passwords, responses to user challenge questions, biometric data, and specialized sensor data accessed through communication links such as retina scans, blood oxygen levels, blood glucose levels, and EKG scans, and may also include behavioral data such as website browsing patterns including online accounts frequented and associations with other users, location and GPS data of the user and/or other users, and so on. It is possible to generate a large amount of UAD in this step, and as a general rule, the more the better.

At step 64, statistical and other analyses are performed on appropriate UAD metrics to develop characterized UAD comprising descriptors of a range of expected results. The UAD may include data that relates directly to identity authentication, such as finger print scans, facial recognition scans and voice prints, and may also include data that can be analyzed for patterns and correlations that can provide inferences as to identity authentication. UAD relating directly to authentication requires analysis to support the comparison process, because identical matches of data taken from the same person are not realistic. Using facial recognition as an example, multiple facial scans may be needed of the specific user's face, and the data characterized as to distinctive features in the face that can be used for effective comparison. Areas of the face can be characterized as more fixed, or more subject to change. As examples, the distance in a scan measured between a person's eyes will change with distance from the camera, which is variable. However, the ratio of the distance between the eyes and the distance from the center of the chin perpendicular to a line through the eyes should remain reasonably constant. While appearances change with hair length, sun tan impacted skin tone and lighting, the shape of the nose should be relatively fixed provided it is mathematically characterized in a manner scalable for camera distance. Location data from a GPS coordinates sensor can be analyzed to create expected user patterns. A user in a location where that user often spends time is more likely to be authentic. A user in a location where that user normally spends time, at a time when that user is normally at that location, is even more likely to be authentic. Thus, patterns of normal activity for a user can be characterized and used to support authenticity. Similarly motion detector data can be used to characterize a user's normal activity. The development of UAD descriptors characterizing a user's normal motion patterns, particularly when correlated with location data, can be helpful in user authentication. People move in different ways, and people engage different activities. If a user characterized in the personal user profile is a 90-year-old partial invalid, and the correlation of location and motion data suggest the current user is jogging down a wooded path, the current user is probably not the user characterized in the personal user profile. More subtle similarities and differences in a comparison to a user's normal pattern are less definitive of identity, but nevertheless contribute to a multi-function calculation of confidence in an identity match.

At step 66, creating and storing of a personal user profile developed from the characterized UAD of the specific user, including the associated descriptors, is performed. The personal user profile comprises characterized UAD relating to the specific user whose UAD was acquired, analyzed and characterized in the steps above. That personal user profile containing characterized UAD is stored on the user device as AUAD (authorized UAD), and available as a basis for comparison to assess authenticity of a current user.

At step 68, UAD metrics from a current user are obtained, corresponding to UAD metrics previously obtained for the specific user whose characterized UAD is in the personal user profile. This current user UAD (CUAD) is obtained in the same way the UAD was obtained for the specific user (AUAD), although it would be expected to be less in quantity because it is generally acquired in a minimally intrusive manner.

At step 70, statistical and other analysis is performed to develop descriptors for appropriate measured UAD from the current user. Since this CUAD would likely be much less than the AUAD used to generate the personal user profile of the authorized user, the descriptors will only be generated for the available UAD, and may be less robust descriptors than those developed for the personal user profile.

At step 72, the characterized UAD developed from the current user (CUAD) is compared with the characterized UAD from in the personal user profile relating to the specific authorized user (AUAD) to generate a confidence index representing the confidence that the current user is the specific user that is represented in the personal user profile. In this process, the similarity of the two sets of characterized UAD are compared to determine the confidence that the current user is the specific user represented in the personal user profile. The resulting confidence is expressed as a confidence index that may be used to support decisions as to whether to accept a user as authentic. The process of determining the confidence index utilizes a plurality of evaluations of comparisons (multimodal comparison), for some of which judgement may be necessary in programming the calculation of confidence. Additionally, combining the various comparisons may require weighting and choosing the basic model for forming the combination, both of which may require judgment on the part of a designer. However, once implemented, the process will provide consistent results and provide a useful tool for determining the authenticity of a device user.

At step 74, the confidence index may be held in memory, and delivered when required for supporting a decision as the whether to accept that the current user as the specific user represented in the user personal user profile.

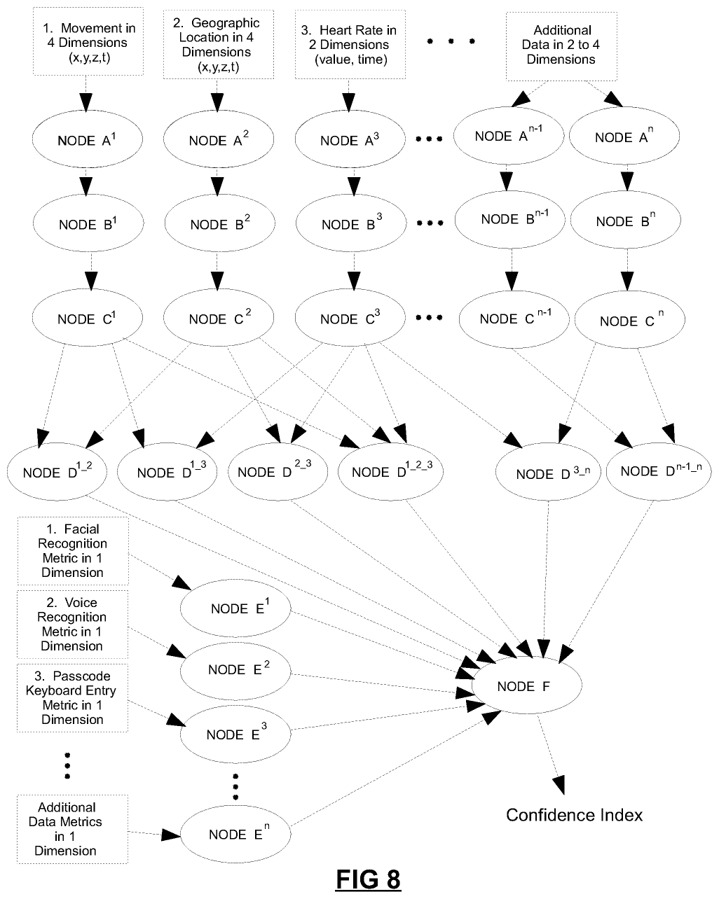

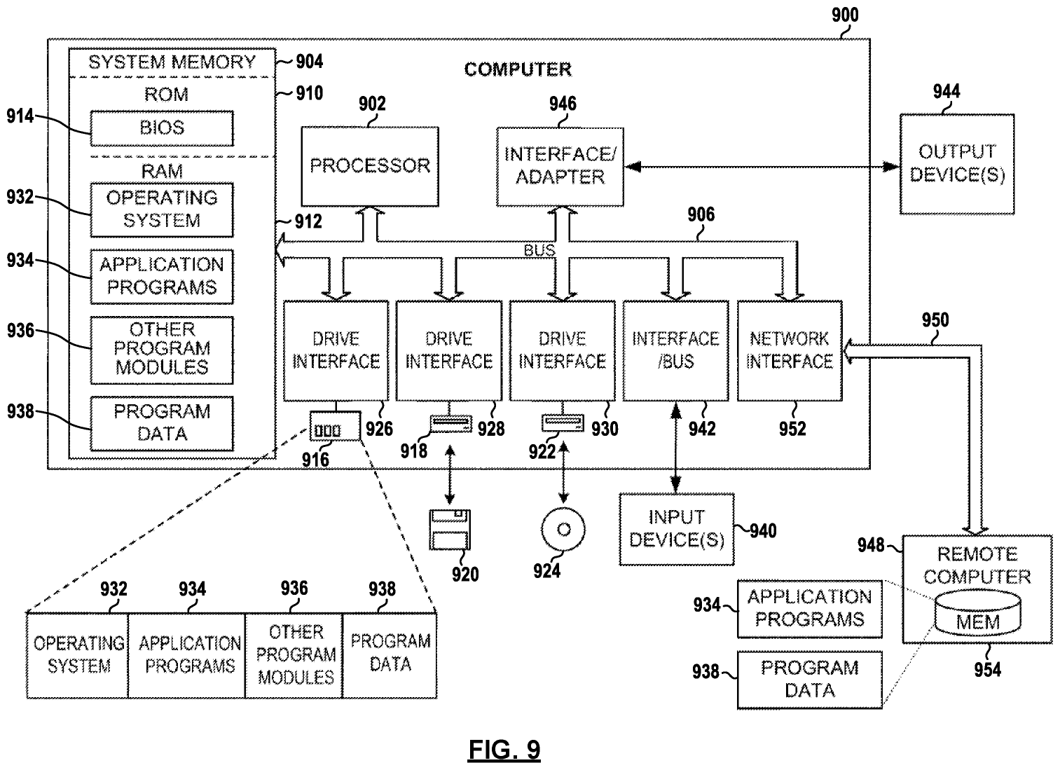

FIG. 8 is a flow diagram showing an example process for analyzing UAD and calculating a confidence index in accordance with the invention and as may be implemented for example by authentication module 21. The process can be performed in hardware such as dedicated logic, a gate array, or a firmware-controlled dedicated semiconductor chip, or in a processor running either firmware or application software. A plurality of sensors and other data sources provide input to the process of determining the confidence index. The data can be of various types, which require differing forms of analysis before combining into an estimate of the degree of confidence in an identity match. Primary indicators of identity such as facial recognition and passcode keyboard entry may be utilized in certain embodiments. Additional inferential identification can also be made using data less directly identity-related when analyzed in a manner that supports identification. The process is described as occurring in calculation nodes, representing stages of the process, and associated characterizations of data at those respective stages.

Node A¹ collects sensor data on the movement of the user device in 4-dimensional space (X, Y, Z, Time). Node A² collects data on the geographic location of the device. Nodes labeled Node A³ through Node Aⁿ collect other types of data like heart rate, breathing, temperature, etc. Node B¹ calculates a pattern of Node A¹ changes over time to develop a composite metric of the normal operating range over various time durations (long, medium, short). Node B² does the same for the data from Node A² and Node Bⁿ for the data from Node Aⁿ etc. Node C¹ compares the mean and variance of the short duration with that of the medium duration and long duration to determine whether movements coming from Node A¹ are consistent with the long-term user's pattern, thereby providing indication as to whether the same person is using the device in the short duration as has used it in the medium and longer durations. Node D¹⁻² analyzes the correlation between the data from Node A¹ and Node A² to determine whether certain movements happen consistently based on where the device is located. For example, the device movements might be very different at the gym compared with sitting on the couch in the living room. The Node B³ through Node Bⁿ function in a manner corresponding to the way Node B¹ and Node B² function, and Node C³ through Node Cⁿ function in a manner corresponding to the way Node C¹ and Node C² function, but each for its respective node data. Single dimension data is analyzed with fewer steps. Facial scan data is compared with facial scan data from the specific authorized user represented in a stored personal user profile, and the degree of match is estimated and represented as a scalar value. A perfect match is not expected due to changes in lighting, distance from camera lens, changes in appearance over time in skin tone, hair length, etc., so the result of the comparison is expected to produce a range of results. The same is true for voice recognition and fingerprint analysis, while the outcome of matching a keyboard entry of a passcode produces a binary output: it either matches or it does not match. Data from each single dimension input source is analyzed in a corresponding node on a Node E layer. Node F receives all of the output from the Node D and Node E layers and calculates a weighted average of the metrics from those Node D and Node E nodes that are currently active, to determine the confidence that the person currently using the device is the person who uses the device in the long-term.

It will be appreciated that while the arrangements set forth herein are mostly described in terms of accessing a user device or a resource device, any device or other system needing security in its access process, whether a building, a vault, a security system, an automobile, or other location or thing, could potentially benefit from the teachings herein.

In view of the foregoing structural and functional description, those skilled in the art will appreciate that portions of the embodiments may be embodied as a method, data processing system, or computer program product. Accordingly, these portions of the present embodiments may take the form of an entirely hardware embodiment, an entirely software embodiment, or an embodiment combining software and hardware, such as shown and described with respect to the computer system of FIG. 9. Furthermore, portions of the embodiments may be a computer program product on a computer-readable storage medium having computer readable program code on the medium. Any non-transitory, tangible storage media possessing structure may be utilized including, but not limited to, static and dynamic storage devices, volatile and non-volatile memories, hard disks, optical storage devices, and magnetic storage devices, but excludes any medium that is not eligible for patent protection under 35 U.S.C. § 101 (such as a propagating electrical or electromagnetic signals per se). As an example and not by way of limitation, computer-readable storage media may include a semiconductor-based circuit or device or other IC (such, as for example, a field-programmable gate array (FPGA) or an ASIC), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, or another suitable computer-readable storage medium or a combination of two or more of these, where appropriate. A computer-readable non-transitory storage medium may be volatile, nonvolatile, or a combination of volatile and non-volatile, as appropriate.

Certain embodiments have also been described herein with reference to block illustrations of methods, systems, and computer program products. It will be understood that blocks and/or combinations of blocks in the illustrations, as well as methods or steps or acts or processes described herein, can be implemented by a computer program comprising a routine of set instructions stored in a machine-readable storage medium as described herein. These instructions may be provided to one or more processors of a general-purpose computer, special-purpose computer, or other programmable data-processing apparatus (or a combination of devices and circuits) to produce a machine, such that the instructions of the machine, when executed by the processor, implement the functions specified in the block or blocks, or in the acts, steps, methods and processes described herein.

These processor-executable instructions may also be stored in computer-readable memory that can direct a computer or other programmable data processing apparatus to function in a particular manner, such that the instructions stored in the computer-readable memory result in an article of manufacture including instructions which implement the function specified. The computer program instructions may also be loaded onto a computer or other programmable data processing apparatus to cause a series of operational steps to be performed on the computer or other programmable apparatus to realize a computer implemented process such that the instructions which execute on the computer or other programmable apparatus provide steps for implementing the functions specified in flowchart blocks that may be described herein.

In this regard, FIG. 9 illustrates one example of a computer system 900 that can be employed to execute one or more embodiments of the present disclosure. Computer system 900 can be implemented on one or more general purpose networked computer systems, embedded computer systems, routers, switches, server devices, client devices, various intermediate devices/nodes or standalone computer systems. Additionally, computer system 900 can be implemented on various mobile clients such as, for example, a personal digital assistant (PDA), laptop computer, pager, and the like, provided it includes sufficient processing capabilities.

Computer system 900 includes processing unit 902, system memory 904, and system bus 906 that couples various system components, including the system memory 904, to processing unit 902. System memory 904 can include volatile (e.g. RAM, DRAM, SDRAM, Double Data Rate (DDR) RAM, etc.) and non-volatile (e.g. Flash, NAND, etc.) memory. Dual microprocessors and other multi-processor architectures also can be used as processing unit 902. System bus 906 may be any of several types of bus structure including a memory bus or memory controller, a peripheral bus, and a local bus using any of a variety of bus architectures. System memory 904 includes read only memory (ROM) 910 and random access memory (RAM) 912. A basic input/output system (BIOS) 914 can reside in ROM 910 containing the basic routines that help to transfer information among elements within computer system 900.

Computer system 900 can include a hard disk drive 916, magnetic disk drive 918, e.g., to read from or write to removable disk 920, and an optical disk drive 922, e.g., for reading CD-ROM disk 924 or to read from or write to other optical media. Hard disk drive 916, magnetic disk drive 918, and optical disk drive 922 are connected to system bus 906 by a hard disk drive interface 926, a magnetic disk drive interface 928, and an optical drive face 930, respectively. The drives and associated computer-readable media provide nonvolatile storage of data, data structures, and computer-executable instructions for computer system 900. Although the description of computer-readable media above refers to a hard disk, a removable magnetic disk and a CD, other types of media that are readable by a computer, such as magnetic cassettes, flash memory cards, digital video disks and the like, in a variety of forms, may also be used in the operating environment; further, any such media may contain computer-executable instructions for implementing one or more parts of embodiments shown and described herein.

A number of program modules may be stored in drives and RAM 910, including operating system 932, one or more application programs 934, other program modules 936, and program data 938. In some examples, the application programs 934 can include authentication module 21 and certification modules 27 and 31, and validation routines 26 and 53, and the program data 938 can include the characterized UAL) and UAD metrics. The application programs 934 and program data 938 can include functions and methods programmed to perform the user authentication, such as shown and described herein.

A user may enter commands and information into computer system 900 through one or more input devices 940, such as a pointing device (e.g., a mouse, touch screen), keyboard, microphone, joystick, game pad, scanner, and the like. For instance, the user can employ input device 940 to edit or modify usernames, adjust confidence index thresholds, and so on. These and other input devices 940 are often connected to processing unit 902 through a corresponding port interface 942 that is coupled to the system bus, but may be connected by other interfaces, such as a parallel port, serial port, or universal serial bus (USB). One or more output devices 944 (e.g., display, a monitor, printer, projector, or other type of displaying device) is also connected to system bus 906 via interface 946, such as a video adapter.

Computer system 900 may operate in a networked environment using logical connections to one or more remote computers, such as remote computer 948. Remote computer 948 may be a workstation, computer system, router, peer device, or other common network node, and typically includes many or all the elements described relative to computer system 900. The logical connections, schematically indicated at 950, can include a local area network (LAN) and/or a wide area network (WAN), or a combination of these, and can be in a cloud-type architecture, for example configured as private clouds, public clouds, hybrid clouds, and multi-clouds. When used in a LAN networking environment, computer system 900 can be connected to the local network through a network interface or adapter 952. When used in a WAN networking environment, computer system 900 can include a modem, or can be connected to a communications server on the LAN. The modem, which may be internal or external, can be connected to system bus 906 via an appropriate port interface. In a networked environment, application programs 934 or program data 938 depicted relative to computer system 900, or portions thereof, may be stored in a remote memory storage device 954.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation used herein are merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third, etc.) is for distinction and not counting. For example, the use of “third” does not imply there must be a corresponding “first” or “second.” Also, if used herein, the terms “coupled” or “coupled to” or “connected” or “connected to” or “attached” or “attached to” may indicate establishing either a direct or indirect connection, and is not limited to either unless expressly referenced as such.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

The invention claimed is:

1. A method for authenticating the identity of a user for granting resource access, the method comprising:
using a user device to obtain, in connection with an authorized user of the user device, authorized user authentication data (AUAD);
using the user device to obtain, for a current user of the user device, current user authentication data (CUAD);
comparing the CUAD with the AUAD;
calculating a confidence index based upon the comparison of the AUAD with the CUAD, the confidence index reflecting a confidence level that the current user is the authorized user; and
making the confidence index available to a resource provider to grant access to a resource if the confidence index is above a predetermined threshold.

2. The method of claim 1, wherein the confidence index is a function of the degree of similarity between the AUAD and CUAD.

3. The method of claim 1, wherein the confidence index is updated iteratively.

4. The method of claim 1, wherein the predetermined threshold is adjustable.

5. The method of claim 1, wherein comparing the CUAD with the AUAD is by way of multimodal analysis.

6. The method of claim 1, wherein said access to the resource is provided to an auxiliary user device.

7. The method of claim 1, wherein said access to the resource is provided to a user terminal, distinct from the user device, by a resource device coupled to the user terminal by way of a router in a closed network.

8. The method of claim 1, further comprising certifying the identity of the user device.

9. The method of claim 8, wherein certifying the identity of the user device comprises generating and exchanging a certification code corresponding to the user device.

10. The method of claim 9, wherein the user device is one of multiple user devices in a peer-to-peer network configured in a mutual certification arrangement.

11. The method of claim 8, wherein certifying the identity of the user device comprises reporting a user device identification code.

12. The method of claim 8, wherein access is granted through a resource device and certifying is performed by a validation device separate from the resource device.

13. The method of claim 12, wherein the validation device serves multiple resource devices.

14. The method of claim 1, wherein the user device is one of multiple user devices in a peer-to-peer network configured in a mutual certification arrangement.

15. The method of claim 1, wherein the CUAD and AUAD include data obtained by one or more sensors of the user device.

16. The method of claim 1, wherein the CUAD and AUAD include data transmitted to the user device from an external source.

17. The method of claim 1, wherein the CUAD and AUAD include data input through a user interface of the user device by the current user and the authorized user, respectively.

18. A machine-readable storage medium having stored thereon a computer program for authenticating the identity of a user for granting resource access, the computer program comprising a routine of set instructions for causing the machine to perform the steps of:
obtain, in connection with an authorized user of the user device, authorized user authentication data (AUAD) that is acquired using a user device;
obtain, for a current user of the user device, current user authentication data (CUAD) that is acquired using a user device;
compare the CUAD with the AUAD;
calculate a confidence index based upon the comparison of the AUAD with the CUAD, the confidence index reflecting a confidence level that the current user is the authorized user; and
make the confidence index available to a resource provider to grant access to a resource if the confidence index is above a predetermined threshold.

19. The machine-readable storage medium of claim 18, wherein the confidence index is a function of the degree of similarity between the AUAD and CUAD.

20. The machine-readable storage medium of claim 18, wherein the confidence index is updated iteratively.

21. The machine-readable storage medium of claim 18, wherein the predetermined threshold is determined by the resource provider.

22. The machine-readable storage medium of claim 18, wherein comparing the CUAD with the AUAD is by way of multimodal analysis.

23. The machine-readable storage medium of claim 18, wherein said access to the resource is provided to an auxiliary user device.

24. The machine-readable storage medium of claim 18, wherein said access to the resource is provided to a user terminal, distinct from the user device, by a resource device coupled to the user terminal by way of a router in a closed network.

25. The machine-readable storage medium of claim 18, the set of instructions further causing the machine to perform the step of certifying the identity of the user device.

26. The machine-readable storage medium of claim 25, wherein certifying the identity of the user device comprises generating and exchanging a certification code corresponding to the user device.

27. The machine-readable storage medium of claim 26, wherein said generating and exchanging a certification code corresponding to the user device is performed each time the user device connects to the resource provider, whereby a new certification code is created and exchanged with initiation of each connection.

28. The machine-readable storage medium of claim 18, wherein the user device is one of multiple user devices in a peer-to-peer network configured in a mutual certification arrangement.

29. The machine-readable storage medium of claim 25, wherein certifying the identity of the user device comprises reporting a user device identification code.

30. The machine-readable storage medium of claim 25, access is granted through a resource device and certifying is performed by a validation device separate from the resource device.

31. The machine-readable storage medium of claim 30, wherein the validation device serves multiple resource devices.

32. The machine-readable storage medium of claim 18, wherein the user device is one of multiple user devices in a peer-to-peer network configured in a mutual certification arrangement.

33. The machine-readable storage medium of claim 18, wherein the CUAD and AUAD include data obtained by one or more sensors of the user device.

34. The machine-readable storage medium of claim 18, wherein the CUAD and AUAD include data transmitted to the user device from an external source.

35. The machine-readable storage medium of claim 18, wherein the CUAD and AUAD include input through a user interface of the user device by the current user and the authorized user, respectively.
